(19) United States
(12) Patent Application Publication
(10) Pub. No.: US 2005/0091369 A1
(43) Pub. Date: Apr. 28, 2005

(54) Method and apparatus for monitoring data storage devices

(76) Inventor: Michael D. Jones, Littleton, CO (US)

Correspondence Address: SHERIDAN ROSS PC, 1560 BROADWAY, SUITE 1200, DENVER, CO, 80202, US

(21) Appl. No.: 10/693,023

(22) Filed: Oct. 23, 2003

(51) Int. Cl. G06F 15/173; G21C 17/00; G06F 15/00; G06F 11/30; G06F 15/16

(52) U.S. Cl. 709/224; 702/186; 709/202

(57) ABSTRACT

The monitoring apparatus includes administrator level software installed in one computer of a computer network, and server agent level software installed in other computers of the computer network having corresponding data storage devices. Log page data of monitored data storage devices is retrieved by the server agent level software and then transmitted to the administrator level software. The log page data is stored in a database at the administrator level software and user interface information is generated from the data stored in the database to provide information to a user regarding the status of each monitored data storage device in the computer network. The user interface information may include explanatory text, predictive analysis, and/or graphical information of both realtime and historical performance of the data storage devices. Accordingly, a very large computer network can be monitored at a single location to determine the general status of each data storage device in the network thereby providing early warning of actual or potential failures of the data storage devices.

### TECHNICAL FIELD

The present invention relates to a method and apparatus for error monitoring of a data processing system, and more particularly, to a method and apparatus of electronically processing data to monitor and record errors which may occur in data storage devices, and further to provide early warning of a potential future failure of data storage devices on computers across a computer network.

### BACKGROUND OF THE INVENTION

Data storage devices are integral parts of all computers and data processing systems to include both large and small computer networks. Data storage devices of the most common types include disk drives and tape drives. As well understood by those skilled in the art, both tape and disk drives have the capability to read and write data based upon software which is installed on each computer application and directs such read/write operations. Like any electromechanical device, data storage devices will ultimately fail over a period of time. According to standard protocols in the computer industry, computers with data storage devices have the capability to record the function of the data storage devices by tracking the amount of data which is read and written, and to further track such data to the extent errors occur in read/write operations. This data is referred to as log page data. Log page data can be accessed by a user to determine the functioning of a particular data storage device. However, a user is simply able to view the pre-formatted log page data, and there is no additional functionality associated with the log page data.

Although this log page data may be available, each computer must be checked individually and the ultimate failure of a particular data storage device occurs without any industry standard warning protocols in terms of integrated software within the computers which will automatically alert a user to either impending failure of the data storage device, or possible failure of the device.

As computer networks continue to advance not only in the amount of data which is manipulated across a network, but also in the type of data which is manipulated, the failure of a data storage device can create a catastrophic effect on the overall integrity of a computer network.

Currently, there are no known software applications which monitor much less predict factors in a computer system with regard to data reliability.

Thus, a system is needed to monitor the reliability of all data storage devices on a network system to prevent catastrophic damage to the system by failure of any storage device in the network. There is also a need to record and analyze data reliability factors which relate to the condition of data which is read, written or otherwise manipulated. Finally, there is also a need for a system which can predict a potential feature failure of a storage device which therefore enables a user to address a potential failure prior to an actual failure.

### SUMMARY OF THE INVENTION

The present invention relates to a data storage management tool that monitors and records the functioning of data storage devices, and also provides predictive analysis of the functioning of the data storage devices to therefore provide early warning of either an impending or possible future failure of a particular storage device. The invention can be defined both as a method of error monitoring of a data processing system, and an apparatus/system for error monitoring of a data processing system.

According to the apparatus/system of the present invention, a computer network is provided having a number of computers which have the ability to communicate with one another through a central server computer, the network corresponding to well-known commercial computer networks which are used within business and government entities. The functionality of the present invention may be achieved through a software application which allows monitoring of each and every data storage device which may exist on the computer network. The software application can be conceptually broken down into an administrator level software application and a server agent level software application. The server agent level includes computer coded instructions/software which is ultimately installed on each computer having its own data storage device(s) in the computer network. The administrator level includes computer coded instructions/software which is installed at a network server computer, or some other designated computer within the network. The administrator software coordinates, organizes, and produces outputs from data gathered from the server agent software installations. The gathered data may be manipulated to provide a user with both realtime and historical information regarding the functioning of each data storage device. The administrator software also provides analytical conclusions directing a user to take appropriate remedial actions, such as to replace a particular storage data device, or take other actions necessary, to prevent loss of data within the computer network.

More particularly, the invention functions by installing the server agent software on each computer that has at least one monitored storage device. The server agent software, once installed, periodically checks the status of each storage device as determined by the corresponding log page data, and then forwards this information to the administrator software over a network connection. The administrator software analyzes and stores the received data in an administrator database, displays the data from each storage device, generates detailed reports based upon analysis of information stored in the database, and provides analysis of the data in order that a user or administrator may make a timely decision to prevent loss of data. Particular warning and/or failure error levels may be established as trigger events. When any trigger event is detected, an electronic message may be sent to the system administrator and/or to other computer users within the network.

Statistical analysis of collected data in the administrator database allows creation of the reports, warning messages, or other outputs which therefore provide early detection of potential failures, or at least of failures which may have just occurred. The present invention also has the capability to track each particular tape or other removable media which is installed on any computer of the network and to notify the system administrator if a faulty tape or other media is later reintroduced for use within a particular computer of the network.

The method and apparatus/system of the present invention results in a comprehensive means to monitor and record potential and actual failures of data storage devices, as well as to provide predictive analysis to prevent data storage device failure by creating reports, messages, or other outputs which enable a user to make a timely decision to replace or repair a particular data storage device. Other objects and advantages of the present invention will be apparent to those skilled in the art from the accompanying figures and the following detailed description of the invention.

### BRIEF DESCRIPTION OF THE FIGURES

FIG. 1 is a schematic diagram illustrating components of a data processing system within the makeup or configuration of a computer network, as well as various installations of software according to the present invention;

FIG. 2 is a flow diagram illustrating the manner in which data storage devices may be discovered on a particular network so they may each receive a server agent software installation;

FIG. 3 is a flow diagram illustrating the manner in which each computer connected to the network may be queried to determine installed server agent software therefore allowing configuration of the server agent software at each computer;

FIG. 4 is a flow diagram illustrating how periodic checks of each data storage device are conducted to retrieve data from each storage device for monitoring, recording, and predictive analysis;

FIG. 5 is a flow diagram illustrating how transfer of information to the administrator software from the various server agent software applications may occur in order to create/update data in the administrator database corresponding to a status of each of the data storage devices in the network;

FIG. 6 is a flow diagram illustrating the manner in which realtime data may be displayed/viewed by a user reflective of the general health/status of each data storage device in the network;

FIG. 7 is a sample user interface screen display which may be generated by the present invention and which provides a general status of each data storage device on the network;

FIG. 8 is another sample user interface screen which provides additional information concerning a selected data storage device that has been identified as having a particular problem;

FIG. 9 is another sample user interface screen which provides yet additional information concerning the data storage device that has been identified as having a particular problem;

FIG. 10 is another sample user interface screen which provides yet additional information on the particular problems of the data storage;

FIG. 11 is another sample user interface screen which may be generated by the present invention and which provides historical information regarding a particular data storage device, and also provides interpretive analysis of the information through instructions to a user;

FIG. 12 is a flow diagram illustrating the manner in which graphical data may be viewed regarding the performance of a particular data storage device;

FIG. 13 is another sample user interface screen which may be generated by the present invention providing graphical information to the user for a particular data storage device, the graphical data explaining information concerning a particular parameter in the performance of the data storage device;

FIG. 14 is another sample user interface screen which may be generated providing additional information regarding the status of the particular data storage device;

FIG. 15 is another flow diagram illustrating how particular parameters associated with a data storage device may be analyzed to detect trends which indicate device degradation and potential failure;

FIG. 16 is a sample report which may be generated by the present invention corresponding to the analysis of data retrieved from a particular data storage device to include predictive analysis resulting in instructions to a user;

FIG. 17 is another sample report which may be generated, similar to the one shown in FIG. 16, but corresponding to analysis of information for a disk drive;

FIG. 18 is a sample user interface screen which may be generated corresponding to analysis of media contents of a particular library; and

FIG. 19 is a flow diagram illustrating the manner in which a particular piece of storage media, such as a tape, may be tracked to prevent reintroduction of the tape that may have been previously identified as being defective.

### DETAILED DESCRIPTION

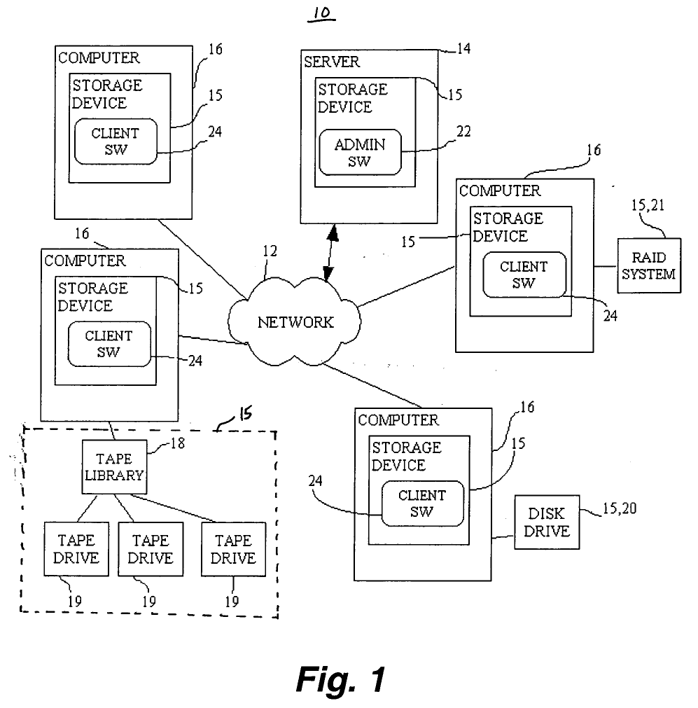

The apparatus/system 10 of the present invention is depicted within the schematic diagram of FIG. 1. The apparatus/system 10 is incorporated within a computer network 12 which includes a plurality of computers 16 which may be in the form of sufficiently powerful personal computers each having their own central processing unit, main memory, disk storage, tape storage, solid state memory, optical drive or other storage device, as well understood in the art. The computers 16 may have or be associated with one or more storage devices 15. For example, a computer 16 may have or be associated with a monitored storage device 15 comprising one or more tape libraries 18, each tape library including one or more tape drives 19. Alternatively, one or more of the computers 16 may have a monitored storage device 15 comprising a single internal tape drive. Additionally, one or more of the computers 16 may have a monitored storage device 15 comprising a disk drive 20, as illustrated. As a further example, a computer 16 may have or be associated with a monitored storage device 15 comprising an external disk drive or disk drive array, such as a RAID system 21. Accordingly, as can be appreciated by one of skill in the art, a monitored storage device 15 may be contained within or interconnected to a computer 16. Furthermore, a monitored storage device 15 may include a freestanding network storage node capable of running server agent software, as will be described in greater detail elsewhere herein. Accordingly, a computer 16 may comprise or be integral with a suitably configured monitored storage device 15. Computers 16 may also be referenced to as client computers. In addition to computers 16, there may be a designated main server computer 14 which manages the network 12. The main server computer 14 may also have its own data storage device 15, which may itself be a monitored storage device.

In accordance with an embodiment of the present invention, the functionality of the present invention may be achieved through various software applications in the form of computer coded instructions or computer software which resides at the main server computer 14, as well as at each of the computers 16. More specifically, the functionality of the present invention is achieved through administrator level software, shown as administrator software 22 which typically resides in the main server computer 14, and various installations of server agent or client software 24 which are shown as residing within the various computers 16. Although the administrator software 22 is shown as being installed within the server computer 14, the administrator software could be installed on any designated computer within the network, the server computer 14 being the one which would most commonly be chosen because other software applications that control the network are also typically installed on the server computer 14. Each of the server agent software installations 24 communicate with the administrator software 22, for example over the network 12, in order to transmit data to the administrator software as dictated by the administrator software. Accordingly, the administrator software 22 also communicates with each of the server agent software installations 24 in order to transmit instructions/commands to the server agent software installations. A user such as a system administrator can control the setup and functioning of the apparatus/system of the present invention at a designated computer terminal 26. Therefore, the functionality of the present invention, as further disclosed below, can be achieved by a user interface at a single terminal for a very large network as opposed to having to physically visit each terminal which may correspond to a particular computer 16. This ability to monitor an entire network at a single administrator location provides a great advantage in maintaining network data integrity without having to access each computer individually from separate terminal locations.

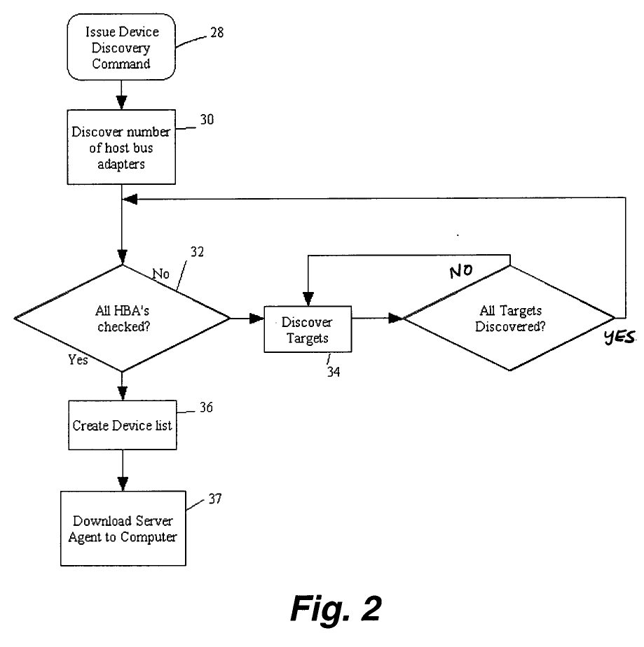

FIG. 2 is a simplified block diagram illustrating basic steps which allow installation of the various server agent software applications. First, a system level call is issued through the administrator software in the form of device discovery commands to determine the number of storage devices that are candidates for monitoring. For example, the system level call may be used to determine how many SCSI or fiber channel host bus adaptors exist on the network and how many storage devices are associated with those adaptors. Each data storage device communicates with its corresponding computer by such adaptors. This system level call is shown at block 28. Based upon these discovery commands, discovery is made of the number of host bus adaptors which exist, shown at block 30. The administrator software then conducts a check to ensure that all host bus adaptors have been checked at block 32, the corresponding targets (data storage devices) are discovered at block 34, and assuming that all targets are discovered, then a device listing is created which corresponds to each storage device located at a particular computer. From this device list, a database is then built within the administrator software which allows each storage device to be monitored, as discussed further below. Creating the device list is shown at block 36. Once each of the data storage devices are discovered, then each computer in the network having a data storage device receives an installation of the server agent software by automatic download from the administrator, shown at step 37. Each installation of the server agent software may have its own local database and functionality to allow the server agent software to communicate with the administrator for purposes of transferring log page data.

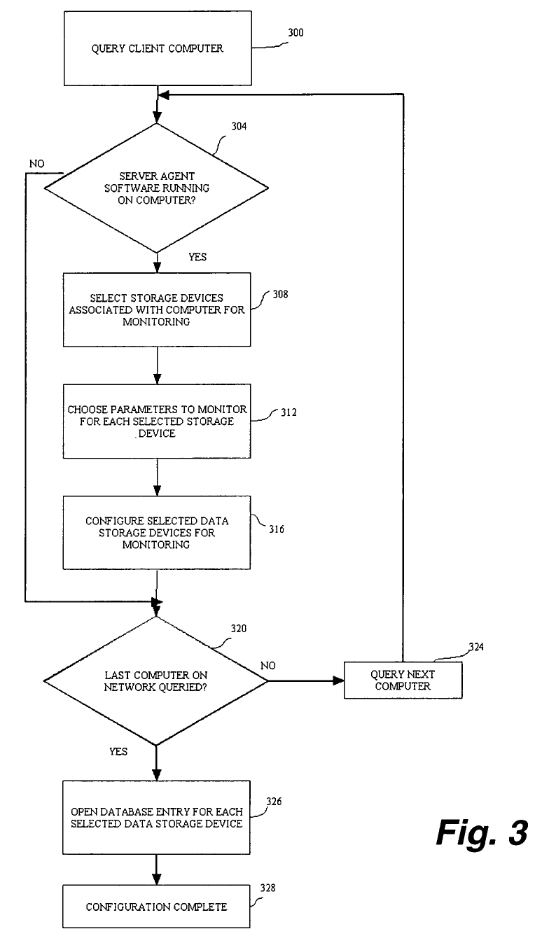

Referring now to FIG. 3, the administrator server queries a client computer 16 interconnected to the network 12 to determine if server agent software is running, at step 300. If it is determined that server agent software is running on the computer, a storage device or devices associated with the computer 16 are selected for monitoring, at step 308. At step 312, parameters to monitor for each selected storage device 15 are chosen. The selected data storage devices 15 are then configured for monitoring, at step 316.

After configuring the selected data storage devices 15, associated with a computer 16 for monitoring, at step 316, or after determining that server agent software 24 is not running on a computer 16 under consideration, a determination is made as to whether the last computer 16 on the network 12 has been queried, at step 320. If the last computer on the network has not been queried, a next computer 16 is queried, at step 324 and the process returns to step 304. If the last computer on the network has been queried, a database entry is open for each selected data storage device, at step 326, and configuration is complete, at step 328.

The administrator may not wish to monitor each and every data storage device 15 on the network, and therefore has the ability to select or not select any particular data storage device for monitoring. However, in the great majority of all applications, an administrator will wish to monitor each and every data storage device. As noted above, for each data storage device, the administrator may choose the particular parameters which are to be monitored for each data storage device. These parameters correspond to the various types of data within the log page data for each type of data storage device. Some log page data is common to all devices, while other log page data is unique to each type of device. Each data storage device is configured for monitoring based upon the parameters which are chosen to be monitored, and configuration is complete as shown at block 44 when an administrator selects all desired devices and chooses parameters for each selected device.

SCSI and Fiber Channel Data Storage Devices maintain statistical information about their own hardware and/or the installed media in the form of linked lists of data known as log page data. This log page data is stored in a non-volatile memory element within each of these types of data storage devices. This log page data is retrieved from the storage devices by using the SCSI log sense commands, as mentioned above. Log page data is organized in a series of data bytes including a log page header, followed by one or more log page parameters. The log page header describes the page code, and the length of parameter data to follow. Log parameter data itself includes a header section which describes a parameter code, one byte which describes the length of a parameter value, and additional multiple bytes which make up the actual parameter value. Accordingly, log page data as retrieved from the storage device includes a series of bytes of data which must be interpreted according to either industry standard log page data and/or log page data which is unique to a particular type of storage device manufactured by a particular manufacturer.

Below is provided a sample listing of some of the industry standard log pages and log parameters:
LOG PAGE 0x02=WRITE ERROR COUNTER PAGE
LOG PAGE 0x02, PARAMETER 0x00=WRITE ERRORS CORRECTED WITH SUBSTANTIAL DELAYS
LOG PAGE 0x02, PARAMETER 0x01=WRITE ERRORS CORRECTED WITH POSSIBLE DELAYS
LOG PAGE 0x02, PARAMETER 0x03=TOTAL WRITE ERRORS CORRECTED

A few examples of manufacturer-unique log pages and log parameters are:
LOG PAGE 0X02, PARAMETER 0X8000=(QUANTUM UNIQUE) TOTAL RE-WRITE COUNT
LOG PAGE 0x02, PARAMETER 0x8002=(QUANTUM UNIQUE) TOTAL DROPOUT COUNT

The terms “parameter” and “parameter data” as used herein refer directly to the log parameters within log page data, such data providing the user of the present invention with information regarding the status of each monitored data storage device.

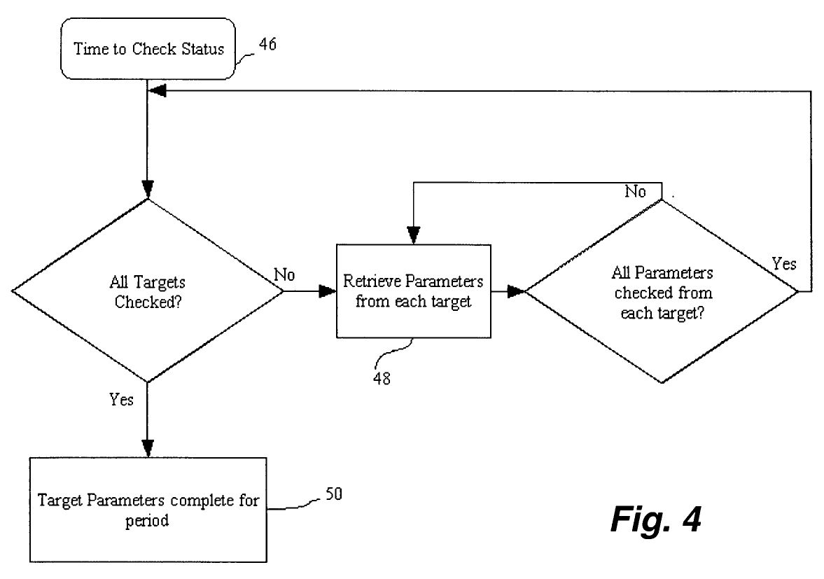

Referring now to FIG. 4, a simplified flow diagram is provided which illustrates the basic method by which data storage devices are periodically checked for monitored parameters. At a time interval as determined by the administrator, the administrator software will issue check status commands shown at block 46 which prompts all data storage devices (targets) to provide their information concerning the performance of each of the corresponding data storage devices for that selected time period. The requests or commands sent by the administrator software are in the form of SCSI log sense commands. Each of the server agent software installations then transmit their data to the administrator. At block 48, the administrator receives the data from the computer associated within each target or storage device selected for monitoring. After all targets are checked, the target parameter information is entered into the administrator database and the update is then considered complete for the preselected time interval, shown at block 50.

If the administrator software cannot be accessed due to a network failure of some type, the parameter data for each data storage device is not lost, but is temporarily stored on each local computer 16 for later retrieval. As mentioned above, each of the server agent software installations include a data base which can be used to store parameter data if such data cannot be successfully transmitted to the administrator software. Accordingly, failure to successfully transfer parameter information to the administrator software automatically results in storage of the parameter data until successful transfer of such data can take place at a later time. Therefore, monitoring of each data storage device will continue uninterrupted despite a temporary failure in the ability to transfer such data to the administrator software.

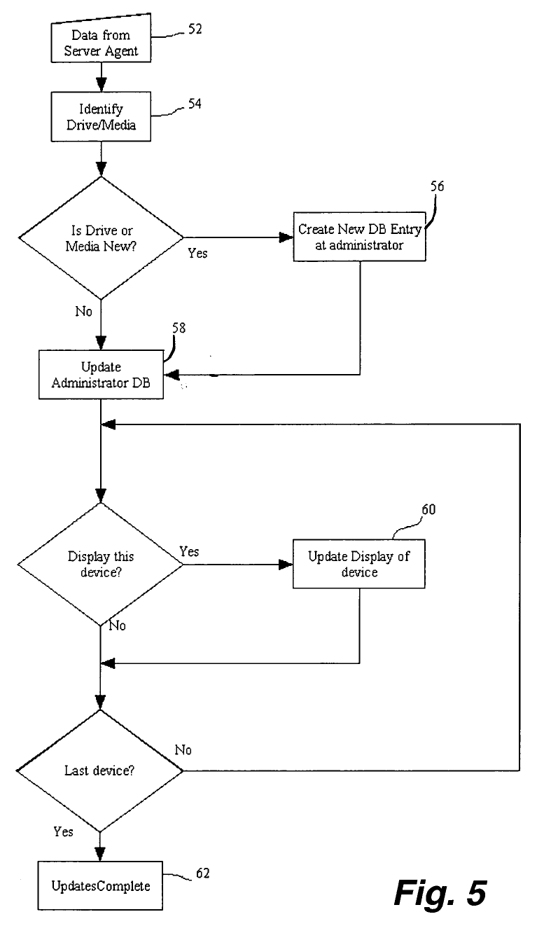

FIG. 5 illustrates another simplified block diagram illustrating more specifically the manner in which the administrator software receives data from the various server agent software installations and how the administrator software database is updated to reflect new data which is received from the server agents. As shown at block 52, parameter data is sent from the various server agents. The received data is then identified by the administrator software as corresponding to a particular disk drive or tape media within the network, as shown at block 54. If a particular computer has been added to the network, the administrator software also checks for data being received from a data storage device that has not previously been monitored. As shown at block 56, if a new disk drive or tape drive has been added, new database entries are created at the administrator database as shown at block 56. All newly received information from the server agents results in a general update of the administrator database as shown at block 58. A user display may be generated corresponding to the information which is received from each server agent. As discussed further below, the display of information can take the form of explanatory text to include reports and/or graphical data. The administrator may choose some or all of the information to be displayed for the various monitored data storage devices in the network. Displayed information is automatically updated based upon updates to the administrator database. The update of the display information is shown at block 60. At block 62, updates are considered complete for the particular time interval once the last device has its corresponding information displayed.

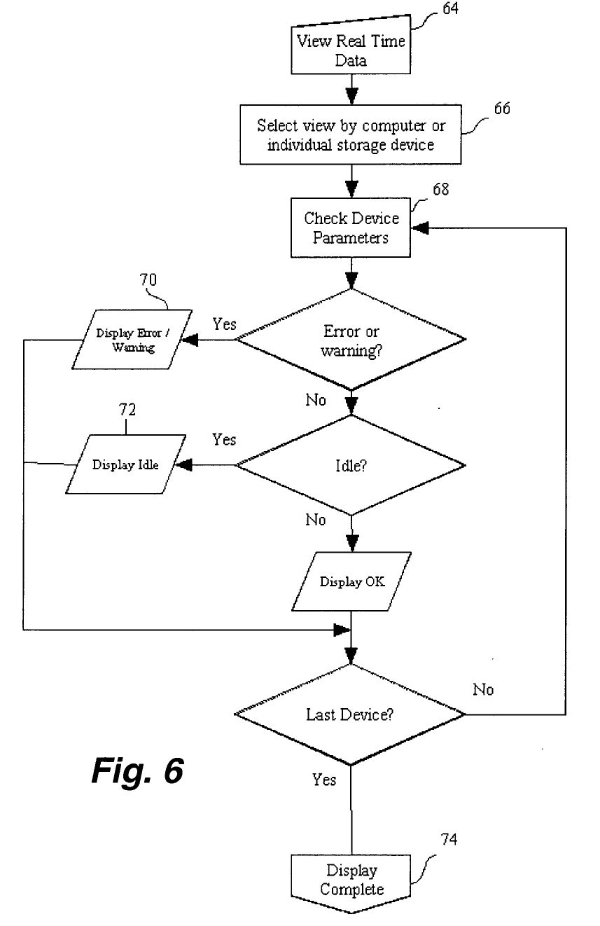

Referring to FIG. 6, information may be viewed for all monitored devices on the network to include realtime information as to the status of each of the data storage devices. Referring to FIG. 6, viewing realtime data shown at block 64 may be achieved by a user selecting various views of the network, either on a computer-by-computer basis, or by individual storage devices, as shown at block 66. As discussed above with respect to FIG. 4, the parameter of each data storage device are transmitted by the server agent software installations to the administrator database. As shown at block 68, the administrator software checks the received parameters. For each monitored parameter of each storage device, a certain level of acceptable performance is established which then defines a triggering event if a threshold level of performance is not achieved. For example, a certain percentage or number of uncorrected read or write errors will result in the administrator software generating an error warning. The error warning can take many forms to include a detailed description of the error and recommended courses of action, as discussed further below. As shown at block 70, when a particular threshold level of performance is not achieved by a particular data storage device, a display error/warning may be generated. Additionally, there may be one or more data storage devices which are not running at the time in which device parameters are checked. In such a case, the particular data storage device may be designated as idle because it is not operating at that time, as shown at block 72. The display is complete as shown at block 74 when all device parameters have been checked, and all display information has been generated.

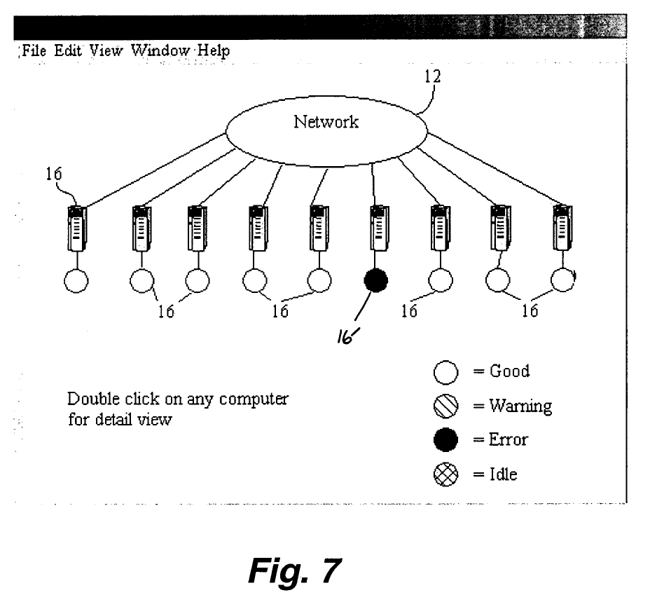

Referring now to FIG. 7, a user interface screen is provided which displays the general status of each computer within the network which has a data storage device. As can be seen, the particular operating software which can be chosen with the present invention may include Windows®; however, other operating systems can be used and it shall be understood that the present invention may be incorporated within any desired operating system. As shown in the figure, the network 12 includes nine separate computers 16 that have a monitored data storage device. An indicator status such as a highlighted/colored circle is provided to differentiate between a properly functioning data storage devices verses those which may fail, or those that may be experiencing present problems. In the example of FIG. 7, a “good” status indicates that a particular computer has each of its data storage device(s) functioning properly. A “warning” status can be provided for those computers having data storage device(s) which may not have yet failed, but may be exhibiting signs of degradation. An “error” status may be provided to show a particular computer having data storage device(s) which are not functioning in accordance with designated threshold standards. Finally, an “idle” status may be provided to indicate that a particular computer is no longer connected to the network, or is not running at that particular time. In FIG. 7, one of the computers 16′ is shown as having an error status.

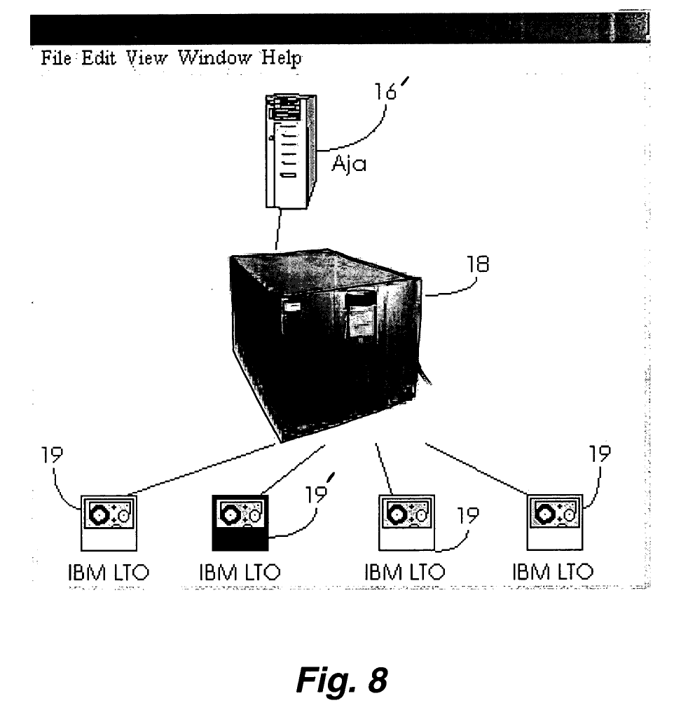

In order to obtain further information about computer 16′, the user could click on the computer icon at computer 16′ which would result in the display shown in FIG. 8. As shown in FIG. 8, the computer 16′ is designated as the “Aja” computer having a tape library 18 with four separate tape drives 19. In FIG. 8, the second tape drive 19′ is the one which is undergoing problems, and is differentiated from the other tape drives 19, such as by darkening the icon corresponding to that particular tape drive. As is also shown in FIG. 8, the particular type of tape library and tape drives may also be designated by manufacture and model type to further assist a user in identifying the data storage device at issue. In FIG. 8, the tape library is a NEO® 4000, while the tape drives are each IBM® LTOs.

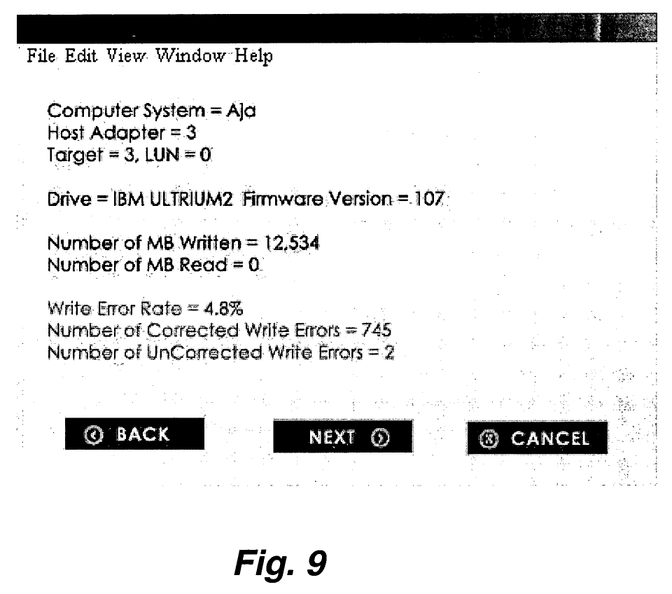

If the user wishes to obtain explanatory text to find out the particular problems associated with a data storage device which has been identified as having a functioning problem, then the user could click on the corresponding icon which would then generate another screen that displays information about the monitored parameters, as shown in at FIG. 9.

In this screen, text is provided which identifies the particular problem of the tape drive 19′. The information displayed identifies the data storage device, and lists monitored parameters. The parameters listed show that the data storage device had achieved a write error rate of 4.8%, there were 745 corrected write errors, and two uncorrected write errors.

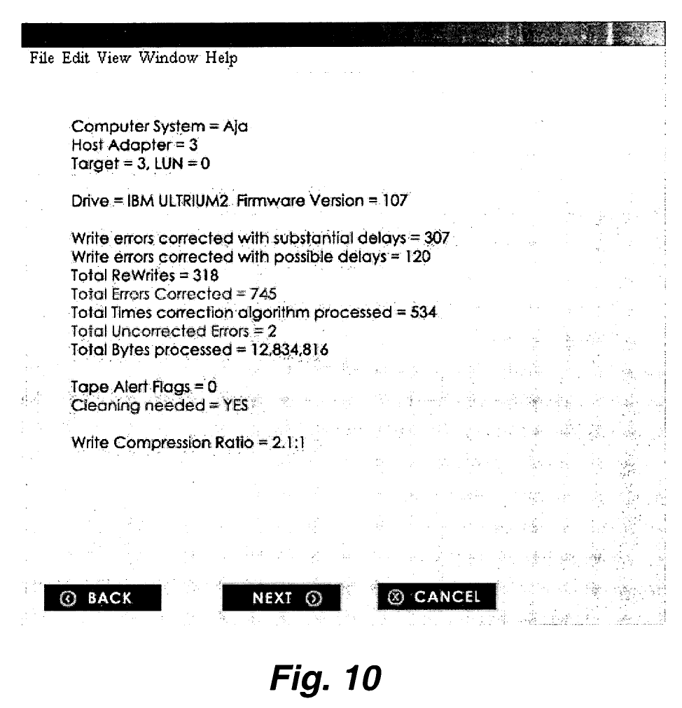

FIG. 10 is yet another user interface screen which may be generated which provides additional information concerning the particular data storage device 19′. A user may select this screen by clicking on the “Next” button of FIG. 9. In this screen, in addition to further describing monitored parameters, some instructional information is provided to the user, such as recommended cleaning of the tape drive.

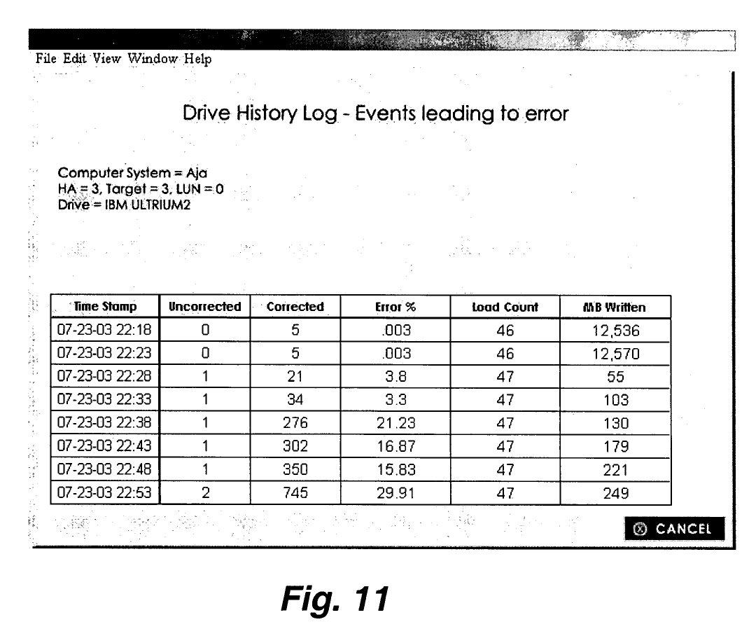

FIG. 11 is another user interface screen which may be provided for a user which provides a history log of events which led up to the generation of the error indication for device 19′. More specifically, FIG. 11 provides information at the relevant points in time in which a malfunction occurred to indicate an explanation of the reason as to why the particular data storage device malfunctioned. With the example of FIG. 11, the error was associated with a tape change which occurred on Jul. 23, 2003 at 10:28 p.m. The screen also provides an explanation of the particular error which is that the tape read error percentage exceeded threshold limits. Finally, FIG. 11 also provides instructions to the user, namely, to copy the data on this tape to another tape, and then do not use the same tape again.

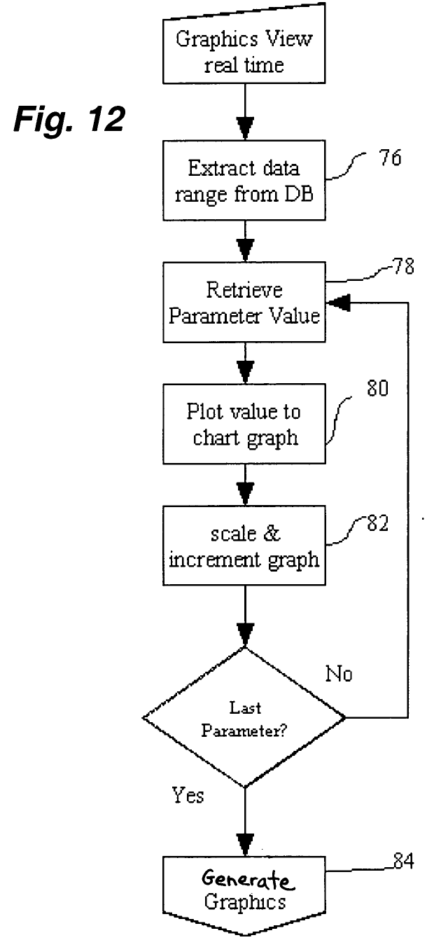

In addition to viewing information corresponding to monitored devices as discussed above with respect to FIGS. 7-11, a user may also wish to view information in graphical format. For example, a user may wish to view a particular monitored parameter, such as read/write errors, as a function of the read/write errors over a particular period of time or in realtime. Referring to FIG. 12, in various set up screens (not shown), the administrator may set up realtime viewing of graphical information by designating/extracting a particular data range from the administrator database, shown at block 76, retrieving parameter values within the selected data range as shown at block 78, plotting the retrieved parameter values to a chart type graph as shown in block 80, and selecting a particular scale and increment for the graph. Based upon these setup limits, the administrator software will generate graphics with the preselected attributes, shown at block 84.

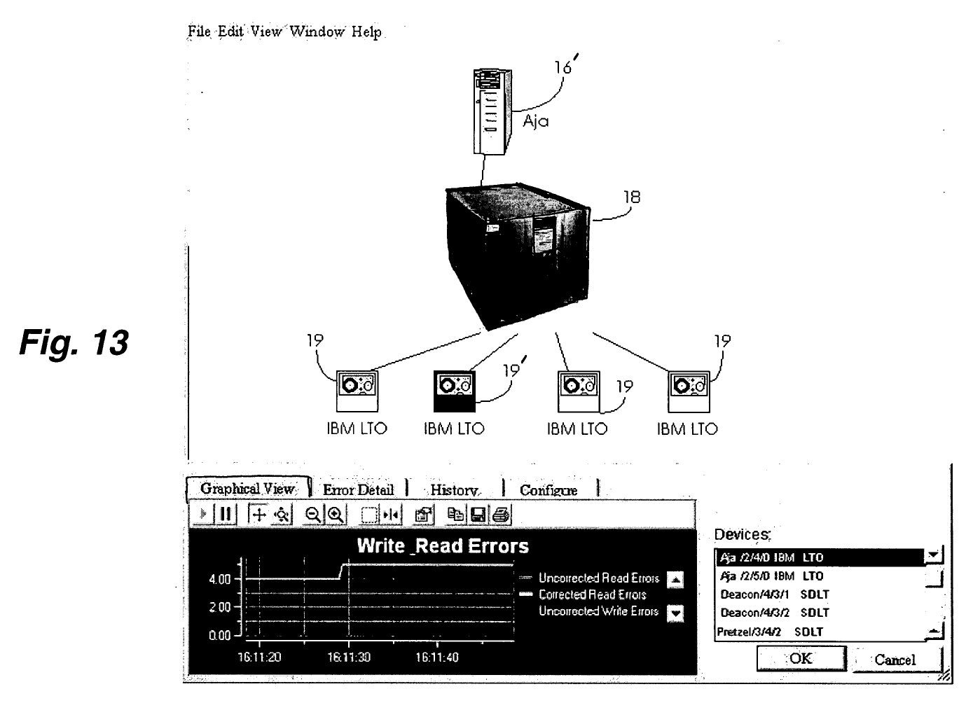

Now referring to FIG. 13, a user interface screen is generated which provides the graphical information corresponding to monitored parameters for any of the data storage devices. In the example of FIG. 13, the graph is one available selection for viewing realtime write/read errors for a particular tape drive. As time passes in the example of FIG. 13, the time scale on the graph would progress in increments of ten seconds, and the actual write/read errors would continually be indicated by the highlighted line. As also shown, a user would be able to select and graphically view one or more types of errors, shown in the figure as uncorrected read errors, corrected read errors, and uncorrected write errors. Additionally, as shown in the pull down menu of FIG. 13, a user could select any particular data storage device to view in terms of realtime graphical information.

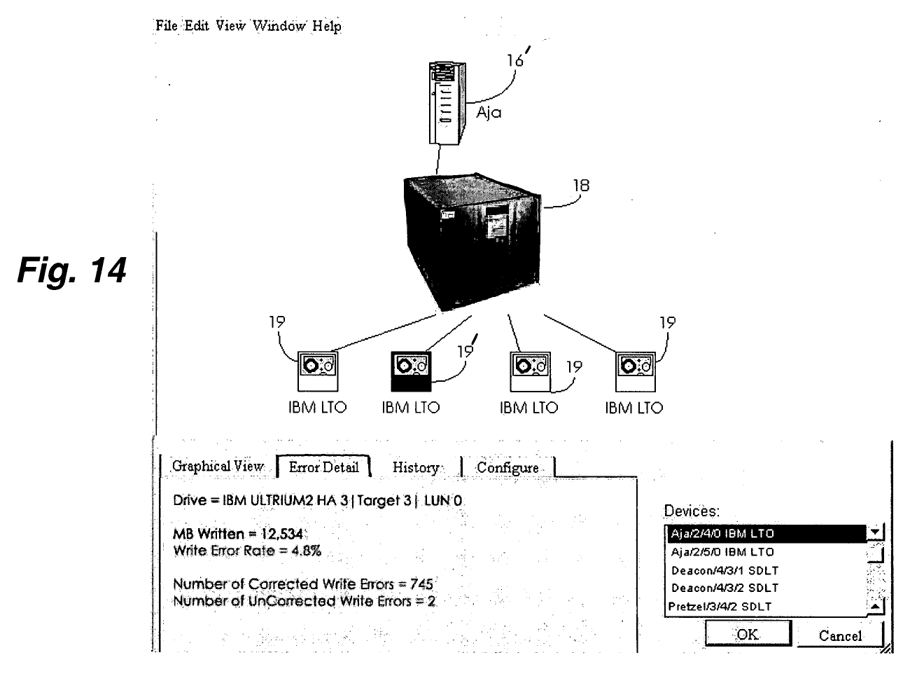

Referring now to FIG. 14, the user would also have the option of clicking on the “Error Detail” tab to view specific information about the particular error which may be occurring at that time. As shown in FIG. 14, the information provided at this screen is similar to the information provided at FIG. 9, the difference being that the Error Detail view of FIG. 14 occupies a smaller portion of the screen and other information continues to be displayed, such as the pull down menu designating the particular device selected for viewing, as well as the icons for the particular computer, tape library, and corresponding data storage devices.

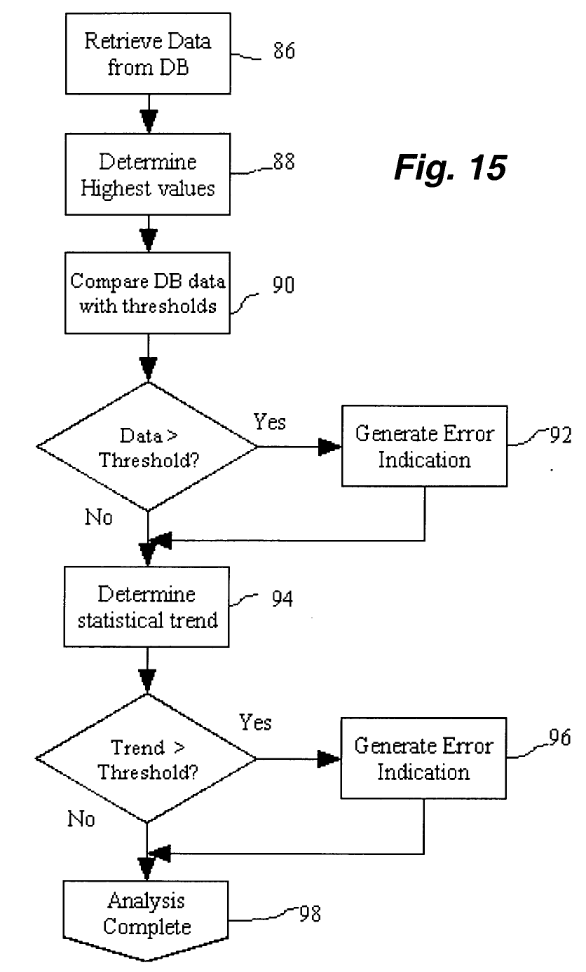

FIG. 15 illustrates another simplified flow diagram illustrating the manner in which parameters associated with a given data storage device may be analyzed to detect trends which indicate device degradation, and which may be further projected to predict device failure. As shown at block 86, the first step is to retrieve data from the administrator database for a particular device to be analyzed. On a per device basis, highest values are determined for monitored parameters, indicated at block 88. The highest values are then compared with acceptable threshold limits for such data, as shown at block 90. If the monitored parameter values for any particular device exceeds an acceptable threshold, then the administrator software can generate an error message/indication, such as generating an error indication in the case discussed above with respect to FIG. 7, as generally indicated at block 92. Additionally, a statistical analysis can be conducted, as shown at block 94, for each of the data points of the monitored parameters which are retrieved from the administrator database, and if the analysis determines that the data points exceed a certain threshold, then yet another error indication can be generated either simultaneous with the first error indication, or separately from the first error indication. Generating this additional error indication is shown generally at block 96. Block 98 indicates the analysis is complete once the error indications are generated.

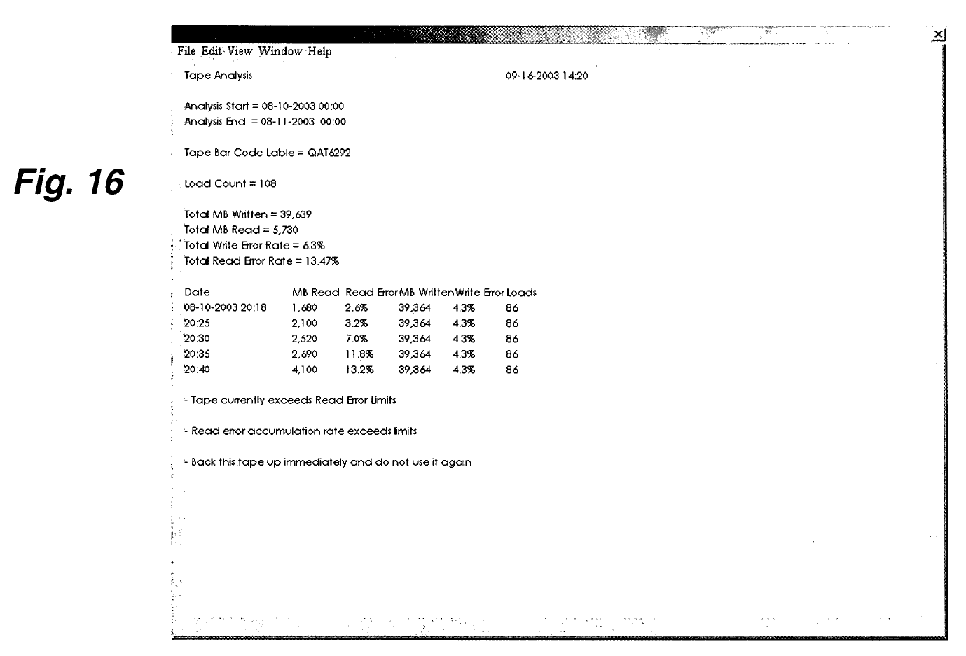

Now referring to FIG. 16, this figure represents a sample report that can be generated to communicate monitored parameters and predictive analysis such as a particular error rate exceeding threshold limits. In the example of FIG. 16, a particular start and end period is provided, as well as analysis of a particular tape. Various monitored parameters are provided over the time period, namely, total megabytes written, total megabytes read, total write error rate, and total read error rate. Additionally, the report provides the monitored parameters at various time intervals within the time period to provide a user with visualization of how, for example, read or write error rates may change over the period. In the example of FIG. 16, write errors remain constant at 4.3%; however, read error rates significantly increase over the time period. Based upon a preset threshold limit, the report further indicates that the particular tape currently exceeds read error limits and further that the read error rate also exceeds limits. Accordingly, the report also provides instructions to the user to backup the particular tape immediately and to not to use it again.

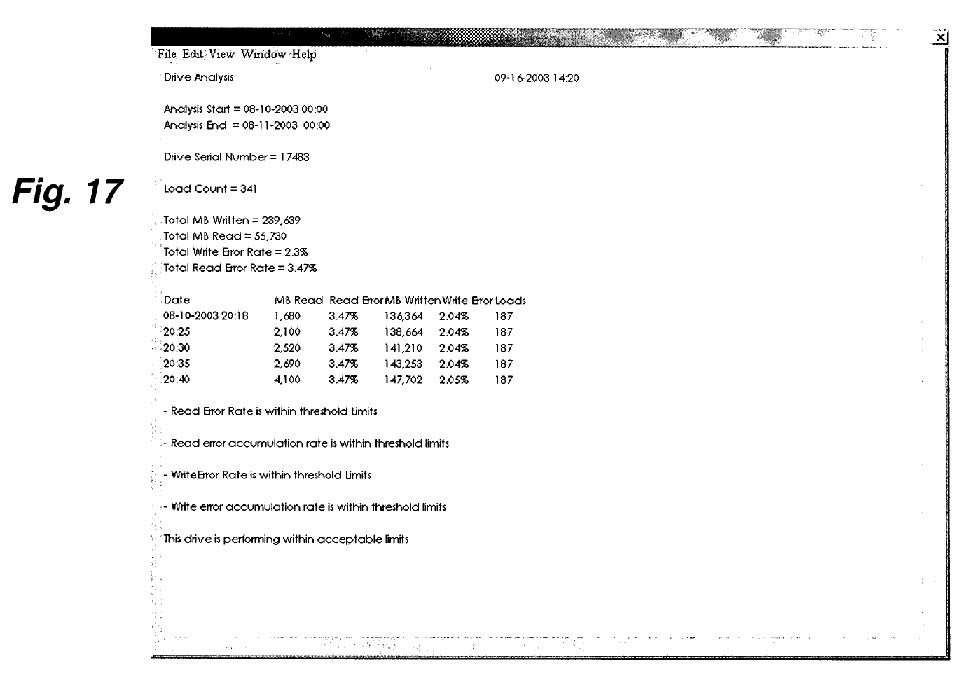

Referring to FIG. 17, an example is provided of a report that can be generated which analyzes another particular data storage device, such as a disk drive. In the example of FIG. 17, information regarding monitored parameters is provided to include a table showing various monitored parameter values during the designated analysis period. In the example of FIG. 17, all read and write error parameters are within limits; therefore, the report concludes that the disk drive is performing within acceptable limits.

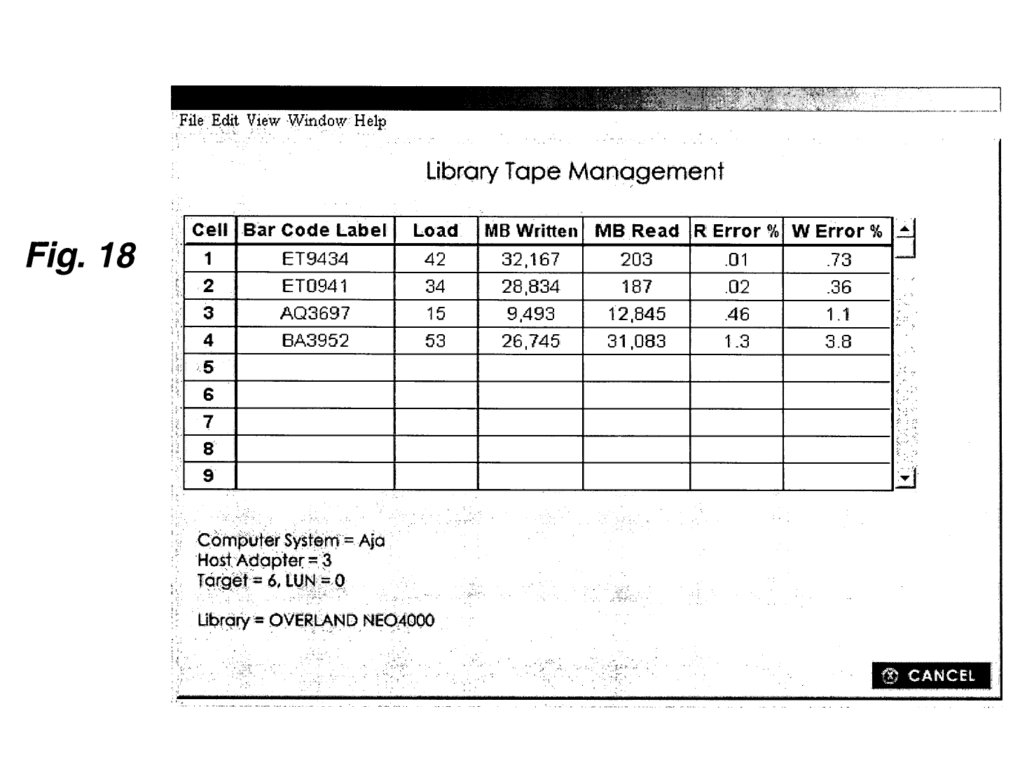

Referring to FIG. 18, in addition to individually displaying information regarding a particular data storage device, either graphically, or in printed text, the performance of a particular library may be provided on a single chart which assists a user in making an immediate comparison, such as relative usage of various data storage devices within the library. According to the user interface screen of FIG. 18, a particular library is identified as having four pieces of tape media/drives each identified by their corresponding bar code labels. The various performance parameters are then provided in the table shown which allows the administrator to quickly compare the parameters between the tape media/drives. Accordingly, FIG. 18 simply represents another manner in which monitored parameters may be viewed on a user interface screen.

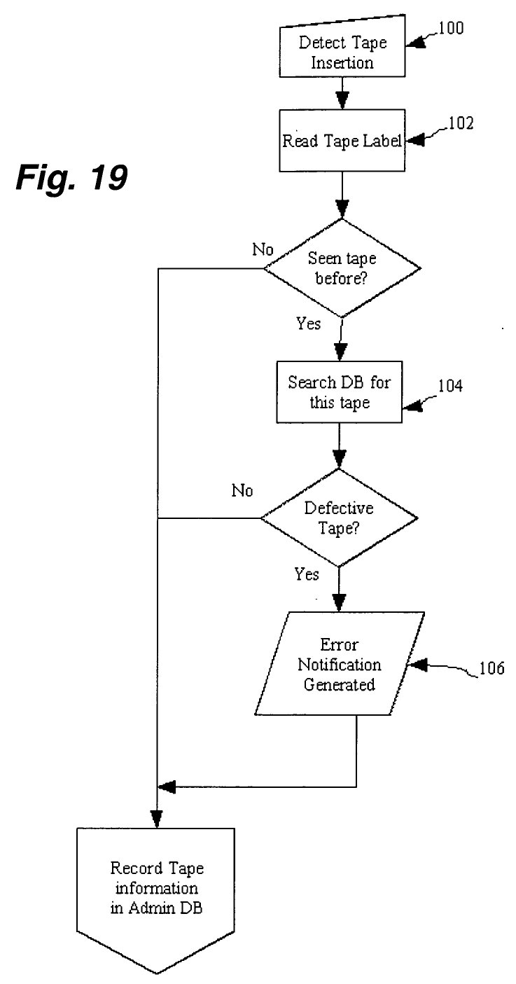

Now referring to the flowchart of FIG. 19, the basic methodology is shown for allowing the system of the present invention to track particular tapes/media which may be used in the network, and to prevent media which was previously identified as being defective from being reused again within the network. For each of the data storage devices, insertion of a new tape, shown at block 100, results in reading of the particular tape label, shown at block 102, as by well known bar code reading techniques. Most tape drives have their own bar code readers which enables recordation of new tapes being used with the tape drive. For each data storage device within the network, the administrator database maintains a listing of such tapes and maintains monitored parameters for each piece of media/tape that has been used in the network. Each time a new tape is used within a tape drive, the detection and reading of the new tape triggers the administrator software to search the administrator database for the particular tape/media, shown at block 104. If the particular tape which has just been inserted has any history of being defective, then an error notification is generated as shown at block 106 which could be in the form of an e-mail to the administrator, or some other error message which would appear on a user interface screen thereby warning of the newly inserted tape. If the tape is new, then the new tape is newly recorded within the administrator database for subsequent recordal of the performance of the particular tape.

By the foregoing, a method and apparatus/system are provided whereby the performance of data storage devices is capable of being monitored in realtime in order to provide timely warning of network problems to an administrator. The apparatus/system is capable of monitoring all log page data made available by a particular equipment manufacturer, and such log page data is used to provide a number of options to an administrator for monitoring the general health of not only individual computers, but individual data storage devices used within or associated with a particular computer. Monitored parameters can be displayed on user interface screens in realtime, in text report formats, or other forms as dictated by set up of the apparatus/system. Even with very large computer networks, an administrator utilizing a single computer terminal can monitor a great number of data storage devices, and can implement immediate remedial actions to prevent potentially catastrophic data losses. With the predictive analysis features of the present invention, a user can set user defined thresholds for determining when the performance of a data storage device is unacceptable.

1. A system for monitoring errors in a network of computers comprising:
a first computer having a processor, integral storage means, and means for electronically communicating with other computers in the network;
a plurality of data storage devices in said network;
a second computer having a processor, integral storage means, and means for electronically communicating with the plurality of data storage devices and said first computer;
first computer software means installed in said first computer for managing data received from said first computer;
second computer software means installed in said second computer for retrieving log page data from said plurality of data storage devices and transmitting said data to said first computer; and
said first computer software means further including means for arranging said log page data in a database and generating user interface information concerning the status of at least one data storage device in the network.

2. A system, as claimed in claim 1, wherein:
said first computer software means further includes means for generating predictive analysis of said log page data in said database, said predictive analysis including user interface information concerning potential failure of said at least one data storage device.

3. A system, as claimed in claim 1, wherein:
said user interface information includes a user interface display of explanatory text regarding the status of said at least one data storage device.

4. A system, as claimed in claim 1, wherein:
said user interface information includes a user interface display of graphical data illustrating a realtime status of said at least one data storage device.

5. A system, as claimed in claim 3, wherein:
said explanatory text is generated in the form of a report including a recommendation to a user regarding an appropriate remedial action to take in the event the at least one data storage device shows failure or degradation.

6. A system, as claimed in claim 1, wherein:
said second software means includes a corresponding database to store said log page data until said data can be successfully transferred to said database of said first software means.

7. A method of monitoring the condition of a plurality of data storage devices in a computer network, said method comprising the steps of:
providing a computer network including a plurality of interconnected computers, at least some of said computers having corresponding data storage devices;
providing administrator level software in one of said computers;
providing server agent software in each computer having a corresponding data storage device to be monitored;
retrieving log page data of a monitored data storage device by said server agent software;
electronically transmitting said log page data to said computer having said administrator level software;
storing said log page data in a database of said administrator level software; and
generating user interface information corresponding to said stored log page data to provide a status of the monitored data storage device.

8. A method, as claimed in claim 7, wherein:
said user interface information includes explanatory text regarding the status of the monitored data storage device;

9. A method, as claimed in claim 9, wherein:
said user interface information includes a graphical display illustrating a realtime status of the monitored data storage device.

10. A method, as claimed in claim 8, wherein:
said explanatory text is generated in the form of a report including recommendations to a user regarding appropriate remedial actions in the event that the monitored data storage device shows failure or degradation.

11. A computational component for performing a method, the method comprising:
selecting a plurality of storage devices for monitoring;
querying a client computer associated with at least a first of said storage devices for storage device data;
receiving said storage device data; and
checking performance parameter information of said at least a first of said storage devices, wherein said performance parameter information is received as part of said storage device data.

12. The method of claim 11, further comprising:
in response to determining that a performance parameter of said at least a first of said storage devices is outside of a predetermined range, generating a status notification.

13. The method of claim 11, further comprising:
characterizing a status of said at least a first storage device.

14. The method of claim 13, wherein said characterizing a status comprises predicting a failure status of said at least a first storage device.

15. The method of claim 14, wherein said predicting a failure status comprises predicting a potential for future failure of said at least a first storage device.

16. The method of claim 12, wherein said status notification comprises a notice displayed to a user.

17. The method of claim 11, wherein said storage device data comprises log page data.

18. The method of claim 11, wherein said performance parameter comprises at least one of storage device read errors and storage device write errors.

19. The method of claim 11, further comprising:
storing said performance parameter data in a database.

20. The method of claim 11, further comprising:
generating a report, wherein said report comprises at least one of said performance parameter information of said at least a first storage device and a status of said at least a first storage device.

21. The method of claim 11, further comprising:
providing server agent software to each said associated client computer.

22. The method of claim 11, wherein said computational component comprises:
a computer-readable storage medium containing instructions for performing the method.

23. The method of claim 11, wherein said computational component comprises a logic circuit.

24. A system for monitoring a status of data storage devices, comprising:
a server computer, including:
data storage;
administrative level software stored in said data storage;
a communication interface;
a communication network interconnected to said communication interface of said server computer;
a client computer, including:
data storage;
a communication interface interconnected to said communication network;
a data storage device; and
server agent software stored in said data storage and operable to query said data storage device for log page data and to provide said log page data to said server computer via said communication network in response to a request from said administrative level software.

25. A monitored computer system, comprising:
means for communicating with a computer network;
means for collecting storage device performance data received from a plurality of storage devices through said means for communicating;
means for storing said collected storage device data;
means for analyzing said collected storage device data, wherein a prediction of a future failure of said storage devices is generated.
